(19) United States
(12) Patent Application Publication
(10) Pub. No.: US 2021/0011194 A1
(43) Pub. Date: Jan. 14, 2021

(54) RISK ASSESSMENT-BASED DESIGN METHOD FOR DEEP COMPLEX FORMATION WELLBORE STRUCTURE

(71) Applicant: CHINA UNIVERSITY OF PETROLEUM, Qingdao (CN)

(72) Inventors: Zhichuan GUAN, Qingdao (CN); Yuqiang XU, Qingdao (CN); Yanan SHENG, Qingdao (CN); Yongwang LIU, Qingdao (CN); Baoping LU, Qingdao (CN); Ke KE, Qingdao (CN)

(21) Appl. No.: 17/033,849

(22) Filed: Sep. 27, 2020

(30) Foreign Application Priority Data
Nov. 13, 2019 (CN) 2019111037553

(51) Int. Cl. G01V 99/00; E21B 47/04; E21B 49/00; G06F 30/20

(52) U.S. Cl. CPC G01V 99/005; E21B 47/04; E21B 43/10; G06F 30/20; E21B 49/00

(57) ABSTRACT

A risk assessment-based design method for a deep complex formation wellbore structure includes: (1) preliminarily determining casing layers and setting depths; (2) calculating to obtain the risk coefficients of each layer of casing; (3) analyzing and coordinating, according to the principle that a shallow casing shares more risks and a deep casing shares less risks, the risks of each layer of casing: determining whether the risk coefficients of each layer of casing are greater than a safety threshold value K; checking the setting depth: if the safety coefficient of an ith-layer casing satisfies R_{Ni}>K, selecting a casing layer with the minimum safety coefficient from upper casing layers, and deepening the setting depth h of the casing layer; and (4) repeating the steps (2) to (3) until the casing risk coefficients of each layer of casing are less than the safety threshold value K.

### FIELD OF THE INVENTION

The present invention relates to a risk assessment-based design method for a deep complex formation wellbore structure, and belongs to the technical field of oil and gas drilling.

### BACKGROUND OF THE INVENTION

Wellbore structure design is one of the important contents of drilling engineering design, and the rationality of a wellbore structure design scheme directly affects safe and efficient implementation of drilling and completion construction.

There are many factors affecting the wellbore structure design, mainly including: safe density window of drilling fluid, a geological setting position, a geological target, drilling cost and the like. Through the research and development of domestic and foreign experts and scholars, basic methods for wellbore structure designs of bottom to top, top to bottom, middle to two sides and mixed designs are gradually formed, which provides a guarantee for safe and efficient construction of drilling and completion in different regions, reservoirs and working conditions. However, as oil and gas exploration gradually moves into the fields of deep water and deep formation, the complexity and uncertainty of a deep formation bring greater challenges to the wellbore structure design: for example, the prediction accuracy of formation pressure is an important guarantee for the rationality of the wellbore structure design, but the prediction of the formation pressure before drilling at present has the problems of high upper formation prediction accuracy and low deep formation prediction accuracy, which results in that, in the wellbore structure design and construction processes, a shallow formation has redundancy in wellbore structure safety, while the deep formation often has risks in wellbore structure safety due to large prediction error of the formation pressure before drilling, and downhole complex situations often occur because of an imperfect wellbore structure design in a construction process. On the other hand, the design coefficient of a common wellbore structure at present is a value range recommended according to a drilling design manual and regional characteristics. In design, only one fixed value can be selected within the value range for designing according to experience and regional drilling data. As a result, the design coefficient of the whole well is a single numerical value, and if the design coefficient is selected too large, there may be redundancy for the shallow formation; and if the design coefficient is selected too small, it may be insufficient for the deep formation.

Therefore, it is necessary to develop a wellbore structure design method with the coordination of risks of each layer of casing based on the concept of risk assessment aiming at the characteristics of deep complex formation drilling and considering the formation prediction error of different well depths and the risk bearing capacity of each layer of wellbore structure.

### SUMMARY OF THE INVENTION

Aiming at the defects in the prior art, the present invention discloses a risk assessment-based design method for a deep complex formation wellbore structure.

### SUMMARY OF THE INVENTION

According to the present invention, in view of the characteristics of insufficient understanding of deep formation information and frequent occurrence of downhole complex situations, the risk of a deep wellbore structure is moderately moved upwards by coordinating the risks borne by the casings of all layers, more design space is provided for the casing layers and the setting depth of a deep formation, the comprehensive risk of the whole wellbore structure is reduced to the maximum extent, and a guarantee for safe and efficient drilling is provided.

The specific technical scheme of the present invention is as follows:

A risk assessment-based design method for a deep complex formation wellbore structure, including:

(1) preliminarily determining casing layers and setting depths;

(2) calculating risk coefficients of each layer of casing;

(3) analyzing and coordinating, according to a principle that a shallow casing shares more risks and a deep casing shares less risks, the risks of each layer of casing:

determining whether the risk coefficients of each layer of casing are greater than a safety threshold value K, and setting the safety threshold value K according to the safety requirement of a target well;

checking the setting depths: if the safety coefficient of an ith-layer casing satisfies R_{Ni}>K, selecting a casing layer with the minimum safety coefficient from upper casing layers, and deepening the setting depth h of the casing layer; and

(4) repeating (2) to (3) until the risk coefficients of each layer of casing are less than the safety threshold value K.

According to the present invention, preferably, the method for preliminarily determining the casing layers and the setting depths in (1) at least includes:

(1-1) determining a geological setting position; namely, determining a setting horizon according to geological data, wherein the “determining a setting point” here is a necessary link in the wellbore structure design, that is, a blocked horizon is determined by analyzing the geological data and regional drilling data according to the horizon and the depth at which the geology is complex and a downhole accident occurs easily, so that a layer of casing must be designed correspondingly for blocking the setting position at the depth (horizon) in actual construction;

(1-2) preliminarily determining a safety pressure window, wherein the safety pressure window is preliminarily determined according to prediction results of formation pore pressure, formation fracture pressure and formation collapse pressure before drilling and a pressure balance relationship of an open hole section; and

(1-3) preliminarily determining the casing layers and the setting depths thereof by a conventional “top to bottom” design method according to the results of (1-1) and (1-2) and a regional wellbore structure design coefficient. The present invention mainly focuses on the prominent problem of the drilling risks of the deep formation in a deep drilling process; therefore, a “top to bottom” method is adopted, which makes each layer of casing go to the deepest and maximizes a design window of the deep formation.

According to the present invention, preferably, the method for calculating to obtain the risk coefficient of each layer of casing in (2) is as follows:

(2-1) probabilistic distribution of formation pressure

the prediction error ΔPᵢ of the formation pressure Pᵢ is a function of the well depth H:

ΔPᵢ=f(H)ϵ[Pᵢ₀,Pᵢ₁] (1)

in formula (1), Pᵢ₀ is the lower limit value of the error, Pᵢ₁ is the upper limit value of the error, and i represents the type of the formation pressure;

the characteristic that the prediction error of the formation pressure before drilling is increased along with the increase of the well depth is introduced into the method of the present invention, and the prediction error of the formation pressure is given by others before design and is subjected to probabilistic distribution in the present invention,

wherein the probabilistic distribution of the prediction error of the formation pressure satisfies the following rule:

$$f ( {P}_{i} ) = \frac{1}{\sqrt{2 π} {σ}_{{p}_{i}}} exp ( - \frac{{( {P}_{i} - \frac{{P}_{i 1} + {P}_{i 0}}{2} )}^{2}}{2 {σ}_{{p}_{i}}^{2}} ) \qquad ( 2 )$$

in formula (2), σ_{P}_{ᵢ} the standard deviation of Pᵢ and is selected according to the prediction accuracy, and the value range is (0, 1); and in the present invention, the risk coefficient is calculated by the cumulative probability of the formation pressure and the cumulative probability of other wellbore structure design coefficients, where σ_{P}_{ᵢ} determines the “width” of a probabilistic distribution function, namely, the width of the upper and lower limits of a prediction function. The wider the probabilistic distribution function is, the more likely a real value falls into a predicted interval, that is to say, the higher the prediction accuracy is, but a large prediction range is not conducive to design.

According to the present invention, a specific error does not need to be obtained, and the prediction accuracy of the function is controlled by selecting different σ_{P}_{ᵢ} values. For example:

for a shallow formation with high prediction accuracy of the formation pressure, in order to increase the design window of a wellbore structure, the width of the upper and lower limits of the prediction function can be reduced moderately, and σ_{P}_{ᵢ} selected between 0.4 and 0.6;

and for the deep formation with low prediction accuracy of the formation pressure, in order to reduce the risk of the wellbore structure, the width of the upper and lower limits of the prediction function can be increased moderately, and σ_{P}_{ᵢ} selected between 0.6 and 0.8.

The cumulative probability corresponding to the predicted value Pᵢ of the formation pressure is:

$$P ( {P}_{i} ) = {\int }_{- ∞}^{{P}_{i}} \frac{1}{{{σ}_{p}}_{i} \sqrt{2 π}} {e}^{- \frac{{( {P}_{i} - \frac{{P}_{i 1} + {P}_{i 0}}{2} )}^{2}}{2 {σ}_{{p}_{i}}^{2}}} {dP}_{i} \qquad ( 3 )$$

for the formation pore pressure, the prediction error is ΔPₚϵ[Pₚ₀, Pₚ₁], and for the formation fracture pressure, the prediction error is ΔP_{f}ϵ[P_{f0}, P_{f1}];

(2-2) probabilistic distribution of wellbore structure design coefficient

if the value range of the wellbore structure design coefficient K is [K₀, K₁], then the probabilistic distribution formula thereof is as follows:

$$f ( K ) = \frac{1}{\sqrt{2 π} {σ}_{K}} exp ( - \frac{{( K - \frac{{K}_{1} + {K}_{0}}{2} )}^{2}}{2 {σ}_{K}^{2}} ) \qquad ( 4 )$$

in formula (4), σ_{K} is the standard deviation of K and is actually selected according to the drilling of a region where a target well is located, and the value range is (0, 1);

if the occurrence frequency of a downhole engineering risk in a regional drilling practice is low, a relatively small σ_{K} value can be selected with regard to a shallow wellbore structure design coefficient; if the occurrence frequency of the downhole engineering risk in the regional drilling practice is high, a relatively large σ_{K} value can be selected with regard to a deep wellbore structure design coefficient; for example: for the shallow formation, σ_{K} is selected between 0.4 and 0.6; for the deep formation, σ_{K} is selected between 0.6 and 0.8;

a credibility J is set to obtain the distribution interval of each design coefficient K as [f₀(K), fₙ(K)]; in the distribution interval, the cumulative probability corresponding to the design coefficient fᵢ(K) is:

$$P ( {f}_{i} ( K ) ) = {\int }_{- ∞}^{{f}_{i} ( K )} \frac{1}{{σ}_{K} \sqrt{2 π}} {e}^{- \frac{{( {f}_{i} ( K ) - \frac{{f}_{1} ( K ) + {f}_{0} ( K )}{2} )}^{2}}{2 {σ}_{K}^{2}}} d ( {f}_{i} ( K ) ) \qquad ( 5 )$$

the distribution intervals of kick tolerance Sₖ, formation fracture pressure safety factor S_{f}, additional drilling fluid density Δρ and suction pressure factor S_{b} are respectively expressed as: [f₀(Sₖ),fₙ(Sₖ)], [f₀(S_{f}), fₙ(S_{f})], [f₀(Δφ,fₙ(Δρ)] and [f₀(S_{b}),fₙ(S_{b})];

according to the present invention, preferably, the value of the credibility J is 70%^{˜}95%;

at present, a common wellbore structure design coefficient is a value range recommended according to a drilling design manual and regional characteristics, and a fixed value is selected from the value range for designing; according to the present invention, a probability statistical method is adopted, regional well structure design coefficients are subjected to probabilistic distribution, and different design coefficients are selected with regard to the risk bearing capacity of each casing layer;

(2-3) downhole engineering risk calculation for an Nth-layer casing at the well depth H

the downhole engineering risk R(H) at the well depth H is calculated according to the pressure balance relationship:

$$\begin{matrix}kick risk \text{:} & ( 6 ) \\ {R}_{J Y} ( H ) = m [ 1 - P ( {P}_{p} ( H ) ) ] \times [ 1 - P ( {f}_{n} ( {S}_{b} ) ) ] \times [ 1 - P ( {f}_{n} ( Δ ρ ) ) ] & \\ where , m = \{ \begin{matrix}0 & {ρ}_{m} > {P}_{p} ( H ) + {f}_{n} ( {S}_{b} ) + {f}_{n} ( Δ ρ ) \\ 1 & {ρ}_{m} \leq {P}_{p} ( H ) + {f}_{n} ( {S}_{b} ) + {f}_{n} ( Δ ρ )\end{matrix} & \end{matrix}$$

risk of lost circulation:

$$\begin{matrix}{R}_{J L} ( H ) = m \times P ( {P}_{f 0} ( H ) ) \times [ 1 - P ( {f}_{n} ( {S}_{k} ) ) ] \times [ 1 - P ( {f}_{n} ( {S}_{f} ) ) ] & ( 7 ) \\ where , m = \{ \begin{matrix}0 & {ρ}_{m} < {f}_{n} ( {S}_{k} ) \times \frac{H}{{H}_{n - 1}} + {f}_{n} ( {S}_{f} ) + {P}_{f 0} ( H ) \\ 1 & {ρ}_{m} \geq {f}_{n} ( {S}_{k} ) \times \frac{H}{{H}_{n - 1}} + {f}_{n} ( {S}_{f} ) + {P}_{f 0} ( H )\end{matrix} & \end{matrix}$$

in formulas (6) and (7), ρₘ is the equivalent density of drilling fluid, and Hₙ₋₁ is the depth of the last casing shoe;

(2-4) determination of risk coefficients of each layer of casing

the downhole engineering risks at the well depth H calculated in (2-3) are integrated within the range of the layer of casing to obtain the overall risk coefficient R_{N} of the Nth-layer casing

R_{N}=∫_{H}_{ₙ}^{H}^{ₘ}(R_{JY}(H)+R_{JL}(H)dH (8)

in formula (8), Hₙ is the minimum depth of the Nth-layer casing; and Hₘ is the maximum depth of the Nth-layer casing.

The present invention has the technical advantages that:

According to the present invention, the above defects can be overcome by performing probabilistic distribution on each of the design coefficients and the prediction errors of the formation pressure and selecting the formation pressure prediction values and the design coefficients of different accuracy for different depths. Meanwhile, the risk coefficient of each layer of casing further can be calculated on that basis, the risks borne by each layer of casing are coordinated, and the overall wellbore structure risk is comprehensively reduced, so that the present invention has great advantages for the wellbore structure design of a deep well complex formation. According to the present invention, the wellbore structure design scheme that each layer of casing shares the risks based on the principle that the shallow casing shares more risks and the deep casing shares less risks is realized, which greatly reduces the safety risk caused by the wellbore structure during the drilling process.

### BRIEF DESCRIPTION OF THE DRAWINGS

FIG. 1 is a specific design contrast diagram for a wellbore structure in an embodiment of the present invention;

FIG. 2 is a flowchart of the present invention.

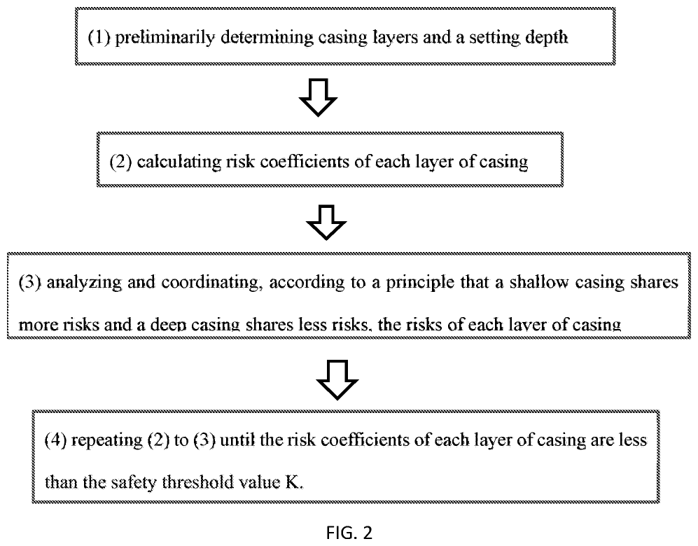

### DETAILED DESCRIPTION OF THE EMBODIMENTS

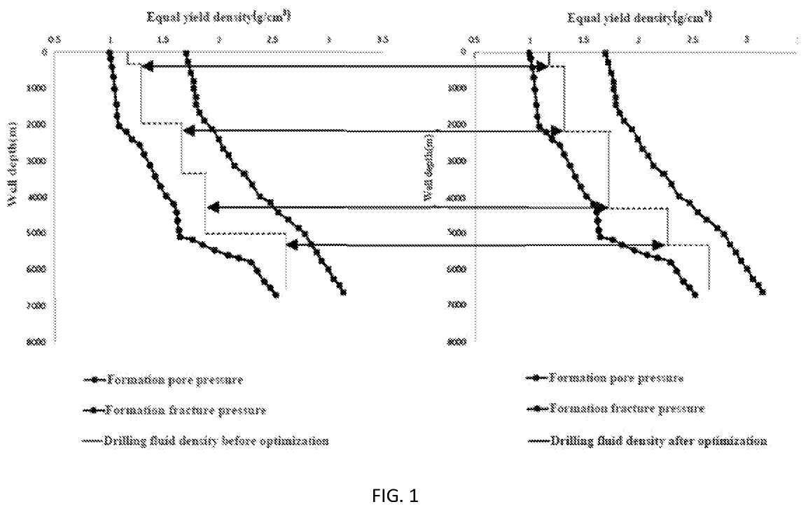

A specific implementation mode is introduced by taking a well A as an example. The design well depth is 6500 m; the kick tolerance Sₖ=0.05 g/cm³, the formation fracture pressure safety factor S_{f}=0.04 g/cm³, the additional drilling fluid density Δρ=0.05 g/cm³ and the suction pressure coefficient S_{b}=0.04 g/cm³. A formation pressure profile is as shown in FIG. 1.

A wellbore structure scheme of the well is preliminarily determined by adopting a top to bottom method according to (1) to (3) of the present invention.

In (2), the error cumulative probability formulas of the formation pore pressure and the formation fracture pressure are respectively obtained as follows by selecting the standard deviation of the formation pressure prediction error σ_{P}_{ᵢ}=0.6:

formation pore pressure:

$$P ( {P}_{p i} ) = {\int }_{- ∞}^{{P}_{pi}} \frac{1}{σ \sqrt{2 π}} {e}^{- \frac{{( {P}_{pi} - \frac{{P}_{pi 1} + {P}_{pi 0}}{2} )}^{2}}{2 {σ}^{2}}} d {P}_{p i} = {\int }_{- ∞}^{{P}_{pi}} \frac{5}{3 \sqrt{2 π}} {e}^{- \frac{25 {( {P}_{pi} - \frac{{P}_{pi 1} + {P}_{pi 0}}{2} )}^{2}}{18}} d {P}_{p i}$$

formation fracture pressure:

$$P ( {P}_{fi} ) = {\int }_{- ∞}^{{P}_{fi}} \frac{1}{σ \sqrt{2 π}} {e}^{- \frac{{( {P}_{fi} - \frac{{P}_{fi 1} + {P}_{fi 0}}{2} )}^{2}}{2 {σ}^{2}}} d {P}_{fi} = {\int }_{- ∞}^{{P}_{fi}} \frac{5}{3 \sqrt{2 π}} {e}^{- \frac{25 {( {P}_{fi} - \frac{{P}_{fi 1} + {P}_{fi 0}}{2} )}^{2}}{18}} d {P}_{fi}$$

According to the drilling experience of an adjoining well in the region, kick and lost circulation easily occur in the downhole with the depth interval of 4000 to 5000 m, so that the wellbore structure design coefficient σ_{P}_{ᵢ}=0.7 is selected for the depth greater than 4000 m, and σ_{P}_{ᵢ}=0.5 is selected for other depths. The credibility J=90% is set to obtain the distribution intervals and the cumulative probability calculation formulas of each of the coefficients as follows:

Kick tolerance: the distribution interval is

$$\{ \begin{matrix}[ 0.04 , 0.06 ] & H < 4000 m \\ [ 0.036 , 0.064 ] & H \geq 4000 m\end{matrix}$$

the cumulative probability formula is

$$P ( {f}_{i} ( {S}_{K} ) ) = \{ \begin{matrix}{\int }_{- ∞}^{{f}_{i} ( {S}_{K} )} \sqrt{\frac{2}{π}} {e}^{- 2 {( {f}_{i} ( {S}_{K} ) + 0.05 )}^{2}} d ( {f}_{i} ( {S}_{K} ) ) & H < 4000 m \\ {\int }_{- ∞}^{{f}_{i} ( {S}_{K} )} \sqrt{\frac{50}{49 π}} {e}^{- \frac{50 {( {f}_{i} ( {S}_{K} ) + 0.05 )}^{2}}{49}} d ( {f}_{i} ( {S}_{K} ) ) & H \geq 4000 m\end{matrix}$$

Formation fracture pressure safety factor: the distribution interval is

$$\{ \begin{matrix}[ 0.032 , 0.048 ] & H < 4000 m \\ [ 0.03 , 0.05 ] & H \geq 4000 m\end{matrix}$$

the cumulative probability formula is

$$P ( {f}_{i} ( {S}_{f} ) ) = \{ \begin{matrix}{\int }_{- ∞}^{{f}_{i} ( {S}_{f} )} \sqrt{\frac{2}{π}} {e}^{- 2 {( {f}_{i} ( {S}_{f} ) + 0.04 )}^{2}} d ( {f}_{i} ( {S}_{f} ) ) & H < 4000 m \\ {\int }_{- ∞}^{{f}_{i} ( {S}_{f} )} \sqrt{\frac{50}{49 π}} {e}^{- \frac{50 {( {f}_{i} ( {S}_{f} ) + 0.04 )}^{2}}{49}} d ( {f}_{i} ( {S}_{f} ) ) & H \geq 4000 m\end{matrix}$$

Additional drilling fluid density: the distribution interval is

$$\{ \begin{matrix}[ 0.04 , 0.06 ] & H < 4000 m \\ [ 0.036 , 0.064 ] & H \geq 4000 m\end{matrix}$$

the cumulative probability formula is

$$P ( {f}_{i} ( {S}_{K} ) ) = \{ \begin{matrix}{\int }_{- ∞}^{{f}_{i} ( {S}_{K} )} \sqrt{\frac{2}{π}} {e}^{- 2 {( {f}_{i} ( {S}_{K} ) + 0.05 )}^{2}} d ( {f}_{i} ( {S}_{K} ) ) & H < 4000 m \\ {\int }_{- ∞}^{{f}_{i} ( {S}_{K} )} \sqrt{\frac{50}{49 π}} {e}^{- \frac{50 {( {f}_{i} ( {S}_{K} ) + 0.05 )}^{2}}{49}} d ( {f}_{i} ( {S}_{K} ) ) & H \geq 4000 m\end{matrix}$$

Suction pressure coefficient: the distribution interval is

$$\{ \begin{matrix}[ 0.032 , 0.048 ] & H < 4000 m \\ [ 0.03 , 0.05 ] & H \geq 4000 m\end{matrix}$$

The cumulative probability formula is

$$P ( {f}_{i} ( {S}_{f} ) ) = \{ \begin{matrix}{\int }_{- ∞}^{{f}_{i} ( {S}_{f} )} \sqrt{\frac{2}{π}} {e}^{- 2 {( {f}_{i} ( {S}_{f} ) + 0.04 )}^{2}} d ( {f}_{i} ( {S}_{f} ) ) & H < 4000 m \\ {\int }_{- ∞}^{{f}_{i} ( {S}_{f} )} \sqrt{\frac{50}{49 π}} {e}^{- \frac{50 {( {f}_{i} ( {S}_{f} ) + 0.04 )}^{2}}{49}} d ( {f}_{i} ( {S}_{f} ) ) & H \geq 4000 m\end{matrix} .$$

According to (2) to (3) in the present invention, in the embodiment, there are five layers of casings in total, and the downhole engineering risks of each layer of casing at different well depths are respectively calculated:

a first-layer casing: the kick risk R_{JY}=0; the lost circulation risk R_{JL}=0;

a second-layer casing: the kick risk

$${R}_{J Y} = \{ \begin{matrix}0 & H < 2000 m \\ 9 \times 1 {0}^{- 6} {x}^{2} - 0.035 x + 35.2 \; 79 & H \geq 2000 m\end{matrix} ;$$

the lost circulation risk R_{JL}=0;

a third-layer casing: the kick risk

$${R}_{J Y} = \{ \begin{matrix}0 & H < 3500 m \\ 2 \times 1 {0}^{- 6} {x}^{2} - 0.0127 x - 23.657 & H \geq 3500 m\end{matrix} ;$$

the lost circulation risk

$${R}_{JL} = \{ \begin{matrix}2 \times 1 {0}^{- 6} {x}^{2} - 0.0091 x + 10.052 & H < 2150 m \\ 0 & H \geq 2150 m\end{matrix} ;$$

a fourth-layer casing: the kick risk

$${R}_{J Y} = \{ \begin{matrix}0 & H < 5150 m \\ 2 \times 1 {0}^{- 6} {x}^{2} - 0.0217 x + 56.027 & H \geq 5150 m\end{matrix} ;$$

the lost circulation risk

$${R}_{JL} = \{ \begin{matrix}- 9 \times 1 {0}^{- 7} {x}^{2} - 0.0067 x - 11.819 & H < 3700 m \\ 0 & H \geq 3700 m\end{matrix} ;$$

a fifth-layer casing: the kick risk

$${R}_{J Y} = \{ \begin{matrix}0 & H < 6380 m \\ 2 \times 1 {0}^{- 6} {x}^{2} - 0.0255 x + 81.718 & H \geq 6380 m\end{matrix} ;$$

the lost circulation risk

$${R}_{JL} = \{ \begin{matrix}- 5 \times 1 {0}^{- 7} {x}^{2} + 0.0055 x - 15.312 & H < 5400 m \\ 0 & H \geq 5400 m\end{matrix} .$$

According to (2) to (4) in the present invention, the overall risk coefficient of each layer of casing is obtained:

R₁=0; R₂=∫₃₀₀²¹⁰⁰ (R_{JY}(H)+R_{JL}(H)dH=0.532; R₃=∫₂₁₀₀³⁶⁰⁰ (R_{JY}(H)+R_{L}(H)dH=0.483;

R₄=∫₃₆₀₀⁵¹⁰⁰(R_{JY}(H)+R_{JL}(H)dH=0.447; R₅=∫₅₁₀₀⁶⁵⁰⁰(R_{JY}(H)+R_{JL}(H)dH=0.408.

According to (3) to (4) in the present invention:

\textcircled{1}: a safety threshold value K=0.5 is set according to actual conditions, wherein the overall risk coefficient of the second-layer casing is greater than the value;

\textcircled{2}: the setting depth of the first-layer casing is increased by 50 m;

\textcircled{3}: if the safety coefficient of the ith-layer casing satisfies R_{Ni}>K, the casing layer with the minimum safety coefficient is selected from upper casing layers, and the setting depth h of the casing layer is deepened; and

\textcircled{4}: until the risk coefficient of each layer of casing is less than the safety threshold value K.

In order to reflect the technical advantages of the present invention, a comparison is made between embodiments of the present invention and comparative examples, wherein the comparative example described in Table 1 refers to a comparative technical scheme formed according to (1) to (2) of the present invention.

TABLE 1

| | Comparative Example | | | | The Present Embodiment | | | |
|---|---|---|---|---|---|---|---|---|
| | | | Drilling | | | | Drilling | |
| | Casing | | Fluid | | Casing | | Fluid | |
| Casing | Setting | | Density | Risk | Setting | | Density | Risk |
| Layer | Depth | | (g/cm³) | Factor | Depth | | (g/cm³) | Factor |
| 1 | 300 | m | 1.17 | 0 | 350 | m | 1.18 | 0.035 |
| 2 | 2100 | m | 1.35 | 0.532 | 2125 | m | 1.37 | 0.0486 |
| 3 | 3600 | m | 1.68 | 0.483 | 3635 | m | 1.72 | 0.043 |
| 4 | 5100 | m | 2.07 | 0.447 | 5110 | m | 2.23 | 0.0421 |
| 5 | 6500 | m | 2.63 | 0.408 | 6500 | m | 2.62 | 0.0413 |

In combination with Table 1 and FIG. 1, it can be seen that, after the processing and design of the method disclosed by the present invention, the risks of the five layers of casings are all less than the safety threshold value K=0.5, the casing setting depth of the shallow formation is deeper, and the depth of the open hole section of the deep formation (the setting depths of the fourth and fifth layers of casings) is reduced, which facilitates the reduction of downhole risk of the deep formation drilling, transfers the risk of a deep casing layer to a shallow casing layer, and reduces the overall risk.

What is claimed is:

1. A risk assessment-based design method for a deep complex formation wellbore structure, comprising:
(1) preliminarily determining casing layers and a setting depth;
(2) calculating risk coefficients of each layer of casing;
(3) analyzing and coordinating, according to a principle that a shallow casing shares more risks and a deep casing shares less risks, the risks of each layer of casing:
determining whether the risk coefficients of each layer of casing are greater than a safety threshold value K;
checking the setting depths: if a safety coefficient of an ith-layer casing satisfies R_{Ni}>K, selecting a casing layer with the minimum safety coefficient from upper casing layers, and deepening the setting depth h of the casing layer; and
(4) repeating (2) to (3) until the risk coefficients of each layer of casing are less than the safety threshold value K.

2. The risk assessment-based design method for the deep complex formation wellbore structure according to claim 1, wherein the method for preliminarily determining the casing layers and the running depths in (1) at least comprises:
(1-1) determining a geological setting position;
(1-2) preliminarily determining a safety pressure window, wherein the safety pressure window is preliminarily determined according to prediction results of formation pore pressure, formation fracture pressure and formation collapse pressure before drilling and a pressure balance relationship of an open hole section; and
(1-3) preliminarily determining the casing layers and the setting depths thereof by a conventional “top to bottom” design method according to the results of (1-1) and (1-2) and a regional wellbore structure design coefficient.

3. The risk assessment-based design method for the deep complex formation wellbore structure according to claim 1, wherein the method for calculating the risk coefficients of each layer of casing in (2) is as follows:
(2-1) probabilistic distribution of formation pressure
the prediction error ΔPᵢ of the formation pressure Pᵢ is a function of the well depth H:
ΔPᵢ=f(H)ϵ[Pᵢ₀,Pᵢ₁], (1)
in formula (1), Pᵢ₀ is the lower limit value of the error, Pᵢ₁ is the upper limit value of the error, and i represents the type of the formation pressure,
wherein the probabilistic distribution of the prediction error of the formation pressure satisfies the following rule:
$$f ( {P}_{i} ) = \frac{1}{\sqrt{2 π} {σ}_{{p}_{i}}} exp ( - \frac{{( {P}_{i} - \frac{{P}_{i 1} + {P}_{i 0}}{2} )}^{2}}{2 {σ}_{{p}_{i}}^{2}} ) \qquad ( 2 )$$
in formula (2), σ_{P}_{ᵢ} the standard deviation of Pᵢ and is selected according to the prediction accuracy, and the value range is (0, 1);
the cumulative probability corresponding to the predicted value Pᵢ of the formation pressure is:
$$P ( {P}_{i} ) = {\int }_{- ∞}^{{P}_{i}} \frac{1}{{σ}_{{p}_{i}} \sqrt{2 π}} {e}^{\frac{{( {P}_{i} - \frac{{P}_{i 1} + {P}_{i 0}}{2} )}^{2}}{2 {σ}_{{p}_{i}}^{2}}} {dP}_{i} \qquad ( 3 )$$
for the formation pore pressure, the prediction error is ΔPₚϵ[Pₚ₀, Pₚ₁], for the formation fracture pressure, the prediction error is ΔP_{f}ϵ[P_{f0}, P_{f1}];
(2-2) probabilistic distribution of wellbore structure design coefficient
if the value range of the wellbore structure design coefficient K is [K₀, K₁], then the probabilistic distribution formula thereof is as follows:
$$f ( K ) = \frac{1}{\sqrt{2 π} {σ}_{K}} exp ( - \frac{{( K - \frac{{K}_{1} + {K}_{0}}{2} )}^{2}}{2 {σ}_{K}^{2}} ) \qquad ( 4 )$$
in formula (4), σ_{K} is the standard deviation of K and is actually selected according to the drilling of a region where a target well is located, and the value range is (0, 1);
a credibility J is set to obtain the distribution interval of each design coefficient K as [f₀(K), fₙ(K)]; in the distribution interval, the cumulative probability corresponding to the design coefficient fᵢ(K) is:
$$P ( {f}_{i} ( K ) ) = {\int }_{- ∞}^{{f}_{i} ( K )} \frac{1}{{σ}_{K} \sqrt{2 π}} {e}^{- \frac{{( {f}_{i} ( K ) - \frac{{f}_{i} ( K ) + {f}_{0} ( K )}{2} )}^{2}}{2 {σ}_{K}^{2}}} d ( {f}_{i} ( K ) ) \qquad ( 5 )$$
the distribution intervals of kick tolerance Sₖ, formation fracture pressure safety factor S_{f}, additional drilling fluid density Δρ and suction pressure factor S_{b} are respectively expressed as: [f₀(Sₖ),fₙ(Sₖ)], [f₀(S_{f}), fₙ(S_{f})], [f₀(Δρ), fₙ(Δρ)] and [f₀(S_{b}),fₙ(S_{b})];
(2-3) downhole engineering risk calculation for an Nth-layer casing at the well depth H
the downhole engineering risk R(H) at the well depth H is calculated according to the pressure balance relationship:
kick risk: R_{JY}(H)=m[1−P(Pₚ(H))]×[1−P(fₙ(S_{b}))]×[1−P(fₙ(Δφ)] (6)
where,
$$m = \{ \begin{matrix}0 & {ρ}_{m} > {P}_{p} ( H ) + {f}_{n} ( {S}_{b} ) + {f}_{n} ( Δ ρ ) \\ 1 & {ρ}_{m} \leq {P}_{p} ( H ) + {f}_{n} ( {S}_{b} ) + {f}_{n} ( Δ ρ )\end{matrix}$$
risk of lost circulation: R_{JL}(H)=m×P(P_{f0}(H))×[1−P(fₙ(Sₖ))]×[1−P(fₙ(S_{f}))] (7)
where,
$$m = \{ \begin{matrix}0 & {ρ}_{m} < {f}_{n} ( {S}_{k} ) \times \frac{H}{{H}_{n - 1}} + {f}_{n} ( {S}_{f} ) + {P}_{f 0} ( H ) \\ 1 & {ρ}_{m} \geq {f}_{n} ( {S}_{k} ) \times \frac{H}{{H}_{n - 1}} + {f}_{n} ( {S}_{f} ) + {P}_{f 0} ( H )\end{matrix}$$
in formulas (6) and (7), ρₘ is the equivalent density of drilling fluid, and Hₙ₋₁ is the depth of the last casing shoe;
(2-4) determination of risk coefficients of each layer of casing
the downhole engineering risks at the well depth H calculated in (2-3) are integrated within the range of the layer of casing to obtain the overall risk coefficient R_{N} of the Nth-layer casing
R_{N}=∫_{H}_{ₙ}^{H}^{ₘ}(R_{JY}(H)+R_{JL}(H)dH (8)
in formula (8), Hₙ is the minimum depth of the Nth-layer casing; and Hₘ is the maximum depth of the Nth-layer casing.
